(19) United States
(12) Patent Application Publication
(10) Pub. No.: US 2007/0252783 A1
(43) Pub. Date: Nov. 1, 2007

(54) Plasma Display Apparatus and Driving Method Therefor

(76) Inventors: Shinichiro Hashimoto, Toyonaka-shi (JP); Masatoshi Kitagawa, Hirakata-shi (JP); Yukihiro Morita, Hirakata-shi (JP); Naoki Kosugi, Kyoto-shi (JP)

Correspondence Address: SNELL & WILMER L.L.P. (Matsushita), 600 ANTON BOULEVARD, SUITE 1400, COSTA MESA, CA, 92626, US

(21) Appl. No.: 10/558,839

(22) PCT Filed: Jun. 4, 2004
(86) PCT No.: PCT/JP04/08159

§ 371 Date: Feb. 22, 2007

(30) Foreign Application Priority Data
Jun. 4, 2003 (JP) 2003-159383

(51) Int. Cl. G09G 3/28

(52) U.S. Cl. 345/60

(57) ABSTRACT

Provided is a plasma display apparatus having largely improved luminous efficiency while restraining cost increase of its driving circuit. A PDP 1 has an outer case formed by attaching a front panel 10 and a back panel 40, with barrier ribs 30 formed therebetween. Besides, a space created between the front panel 10 and the back panel 40 is filled with a rare gas such as Ne, Xe, and He. On the back panel 40, data-sustain electrodes 52 and data electrodes 51 are aligned alternately and parallel to each other. In a write period, a data driving circuit 4 performs selective data voltage output to the data electrodes 51 based on image data inputted for each subfield line by line. In a sustain period, a data-sustain driving circuit 5 performs collective data-sustain pulse application to the data-sustain electrodes 52.

### TECHNICAL FIELD

The present invention relates to a plasma display panel and a driving method therefor.

### BACKGROUND ART

Screen size increase is relatively easy with plasma display panels (PDP) compared to cathode ray tubes (CRT) that are currently most commonly used. Because of this characteristic, the PDPs are expected to replace CRTs as a television image display apparatus in the era of high-definition televisions. The PDPs are broadly classified into an alternating current type (AC type) and a direct current type (DC type). Of these two types, the AC-type PDPs are currently favored for their reliability, image quality characteristics, and so forth.

FIG. 13 is a perspective diagram showing the structure of an AC type PDP that relates to a conventional example.

A PDP 101 has an outer case formed by attaching a front panel 110 and a back panel 140, with barrier ribs 130 formed therebetween. Besides, the space created between the front panel 110 and the back panel 140 is filled with a rare gas such as Ne, Xe, and He.

On the surface of the front panel 110, a plurality of pairs of display electrodes 120 are arranged parallel to each other, where each pair of display electrodes 120 is composed of a scan electrode 121 and a sustain electrode 122 that extend in a row direction. In addition, a first dielectric film 111 and a protection film 112 are formed with respect to the front panel 110 to cover the pairs of display electrodes 120. On the surface of the back panel 140 that faces the front panel 110, data electrodes 151 extending in the column direction are arranged. In addition, a second dielectric film 141 is formed over the back panel 140 to cover the data electrodes 151. On the second dielectric film 141, barrier ribs 130 are provided, so that one barrier rib is positioned between two adjacent data electrodes 151. Moreover on the second dielectric film 141, red, blue, and green colored phosphor layers 142 are provided so that one phosphor layer 142 is positioned between two adjacent barrier ribs 130. In this PDP 101, discharge cells are formed where the pairs of display electrodes 120 cross over the data electrodes 151.

The PDP 101 is connected to a scan driving circuit that drives the scan electrodes 121, a sustain driving circuit that drives the sustain electrodes 122, and a data driving circuit that drives the data electrodes 151. These driving circuits are respectively structured by a semiconductor chip, for example.

Next, a method of driving the PDP 101 is described. A commonly employed method of driving the PDP apparatuses (plasma display apparatuses?) is a field time-sharing grayscale display method having a write period and a sustain period. Specifically, according to this method, one field is divided into a plurality of subfields as shown in FIG. 14. Images for the subfields are then chronologically integrated so as to display the field in grayscale.

Each subfield includes an initialization period, a write period, and a sustain period. In the initialization period, an initialization pulse is applied to the scan electrodes 121 thereby generating an initialization discharge in each discharge cell.

In the write period, the scan driving circuit performs scan pulse application sequentially to the scan electrodes 121, and the data driving circuit performs data pulse application selectively to the data electrodes 151 based on inputted image data, thereby generating a write discharge in discharge cells corresponding to the image data.

In the sustain period (see FIG. 15), by maintaining the data electrodes 151 to a certain voltage, sustain pulse is applied alternately to the scan electrodes 121 and the sustain electrodes 122 for all of them. As a result, in the discharge cells having undergone the write discharge, the summation of the electric potential difference between the scan electrodes 121 and the sustain electrodes 122 and the electric potential difference due to the wall charge exceeds the discharge starting voltage, thereby causing a sustain discharge to occur.

In such a PDP, it is desired to improve the luminous efficiency. There have been already efforts made from various aspects for improving the luminous efficiency.

One of such efforts is to employ the data electrodes in the sustain period as well as in the write period.

For example the Japanese Laid-open patent application No. H11-143425 discloses the following technology to improve the luminous efficiency. In this technology, while performing sustain pulse application to the scan electrodes and the sustain electrodes, positive narrow pulse is simultaneously applied to the data electrodes, thereby generating a discharge to the level that would not extinguish the wall charge, between the data electrodes and any electrodes among the scan electrodes and the sustain electrodes with respect to which a negative wall charge has been formed. Triggered by the discharge, a sustain discharge is generated between the scan electrodes and the sustain electrodes.

In addition, a technology is already known for lowering the discharge starting voltage between the scan electrodes and the sustain electrodes, by the priming effect caused due to a preliminary discharge generated, during the sustain period, by application of a preliminary discharge voltage to the data electrodes prior to the sustain discharge. This technology is disclosed by the Japanese Laid-open patent application No. 2001-5425.

As stated above, pulse application to the data electrodes also in the sustain period is effective for improving the luminous efficiency. However, further improvement of the luminous efficiency is desired for the PDPs.

Here, it is also considered effective, for the purpose of improving the luminous efficiency, to endow a large resistance to a driver device constituting the data driving circuit, thereby allowing application of pulses in larger voltage amplitude to the data electrodes during the sustain period.

However, so as to realize data pulse application selectively to the data electrodes based on image data, the data driving circuit has to have driver devices in the same number as the data electrodes, and so has a complicated structure. Therefore, if each of the driver devices is endowed with high resistance, the manufacturing cost of the data driving circuit would considerably increase, and semiconductor chips constituting the data driving circuit increase in size as well. Therefore in reality, the resistance of a driver device used for a data driving circuit is about 80V at most, and the improvement in luminous efficiency expected in the stated method is accordingly confined.

### DISCLOSURE OF THE INVENTION

The present invention aims to provide a PDP apparatus having largely improved luminous efficiency while restraining cost increase of the driving circuit.

So as to achieve the above-stated object, the present invention provides a PDP apparatus including a plasma display panel having an outer case provided with: pairs of display electrodes extending in a row direction; first column electrodes extending in a column direction; and second column electrodes extending in the column direction such that each first column electrode has at least one side thereof that is adjacent to a second column electrode, the first column electrodes opposing the pairs of display electrodes at a distance therefrom, a plurality of discharge cells being formed where the pairs of display electrodes face the first and second column electrodes; and a driving unit operable to drive the plasma display panel using a method having a write period and a sustain period, the driving unit including: a data driving circuit that performs, in the write period, data voltage application selectively to the first column electrodes; and a sustain driving circuit that performs, in the sustain period, voltage application collectively to the second column electrodes.

According to the above-stated structure of the PDP apparatus, the second column electrodes will be aligned parallel to the first column electrodes. Accordingly, each of the discharge cells will face a second column electrode as well, in addition to a pair of display electrodes and a first column electrode.

Therefore, a PDP is driven by a method in which data voltage application is performed selectively to the first column electrodes by means of the data driving circuit, thereby generating write discharge to the discharge cells to conduct writing, and after this, voltage application is performed collectively to the second column electrodes by means of a sustain driving circuit while sustain voltage is applied to display electrodes in each pair of display electrodes, thereby generating sustain discharge in every discharge cell having undergone the write discharge. In the above description, the expression “performing data voltage application selectively” indicates that only selected first column electrodes will be provided with data voltage. In addition, the expression “performing voltage application collectively” indicates that voltage of a same waveform is applied to all the second column electrodes simultaneously. This also applies to all similar expressions hereinafter.

Here, the sustain driving circuit may perform collective voltage application to the second column electrodes. Therefore, the number of driver devices may be small. In fact, at least one driver device is sufficient for the sustain driving circuit. Accordingly, there will not be so much cost increase even if the sustain driving circuit adopts a high resistance device.

In the stated structure, if a high resistance driver device is adopted for the sustain driving circuit, it is possible to improve luminous efficiency by increasing the amplitude of the voltage applied to the second column electrodes while restraining cost increase.

In addition, the data driving circuit and the sustain driving circuit perform voltage application to different electrodes from each other. Therefore, the output from one of the driving circuits will never enter the other of the driving circuits.

It should be noted that according to studies conducted by the study group constituted by the inventors of the present invention, it has been found that the luminous efficiency will improve as the increase in amplitude of the voltage applied to the second column electrodes in the sustain period.

Here, for the purpose of improving the luminous efficiency, it is preferable that the voltage applied by means of the sustain driving circuit with respect to the second electrodes in the sustain period be in pulse form.

In the PDP apparatus of the present invention mentioned above, the alignment of the first column electrodes and the second column electrodes to face the discharge cells may be in such a way that the first column electrodes and the second column electrodes alternate one by one, as described in the first embodiment. Alternatively, as shown in the second and third embodiments, the alignment may be to include at least one pair of first column electrodes that are adjacent to each other. Here, the expression “at least one pair of first column electrodes that are adjacent to each other” indicates a situation where there is no second column electrode between the pair of first column electrodes.

With the stated structure, when the sustain driving circuit applies voltage to the second column electrodes in the sustain period, charge and discharge will occur wherever a first column electrode and a second column electrode are adjacent to each other, thereby causing a reactive current. In particular, a reactive current tends to be generated when the voltage applied to the second column electrodes in the sustain period is in pulse form. However, by forming at least one pair of adjacent first column electrodes as stated above, there will be smaller number of places where a first column electrode and a second column electrode are adjacent to each other. This will contribute to reduction in reactive current, when compared to the case where the alignment is such that the first column electrodes and the second column electrodes alternate one by one.

The following describes some of the concrete examples where at least one pair of adjacent first column electrodes is included.

In one of the concrete examples, the first column electrodes and the second column electrodes are aligned such that pairs of first column electrodes alternate with pairs of second column electrodes, as shown in the second embodiment. In this case, one second column electrode is designed to face one column of discharge cells.

On the other hand, it is also possible to have a structure in which a second column electrode that is aligned adjacent to the pair of adjacent first column electrodes at one side is adjacent to a first column electrode at the other side, as shown in the third embodiment. Furthermore, it is also possible to have a structure in which the first column electrodes and the second column electrodes are aligned such that pairs of first column electrodes alternate with second column electrodes.

In these cases, one second column electrode is adjacent to a pair of first column electrodes at one side, and is adjacent to one first column electrode at the other side. Therefore, it is possible to apply voltage to two columns of discharge cells simultaneously.

In the above-stated PDP apparatus, it becomes possible to perform collective voltage application to the second column electrodes by means of only one driver device, if the second column electrodes are electrically connected to each other.

If the above-stated PDP apparatus of the present invention further has a structure in which phosphor layers are formed in the discharge cells along the second column electrodes, it is further possible to shape the second column electrodes differently from each other depending on kinds of corresponding phosphor layers. Alternatively, in the structure, it is further possible to change amplitude of voltages that the sustain driving circuit applies to the second column electrodes depending on kinds of phosphor layers corresponding to the second column electrodes respectively.

So as to achieve the above-stated object, the present invention further provides another PDP apparatus including a plasma display panel having an outer case provided with pairs of display electrodes extending in a row direction and column electrodes extending in a column direction, the column electrodes opposing the pairs of display electrodes at a distance therefrom, a plurality of discharge cells being formed where the pairs of display electrodes face the column electrodes; and a driving unit operable to drive the plasma display panel using a method having a write period and a sustain period, the driving unit including: a data driving circuit that performs, in the write period, data voltage application selectively to the column electrodes; a sustain driving circuit that performs, in the sustain period, voltage application collectively to the column electrodes; and a switching unit operable to switch connection of the column electrodes, between connection to the data driving circuit and connection to the sustain driving circuit.

According to this PDP apparatus too, it is possible to switch connection of the column electrodes, between connection to the data driving circuit and connection to the sustain driving circuit. In other words, the column electrodes will be in selective connection to the mentioned driving circuits, so that the column electrodes are connected to only one of the data driving circuit and the sustain driving circuit at a time. Therefore, it is possible to drive the PDP by a method in which: in the write period, data voltage application is performed selectively to the column electrodes, thereby selectively generating write discharge to the discharge cells to conduct writing; in the sustain period, voltage application is performed collectively to the column electrodes by means of a sustain driving circuit, thereby generating sustain discharge in every discharge cell having undergone the write discharge in the write period.

Here, the sustain driving circuit may perform collective voltage application to the column electrodes. Therefore, the number of devices may be small. In fact, at least one device is sufficient for the sustain driving circuit. Accordingly, there will not be so much cost increase even if the sustain driving circuit adopts a high resistance device.

Therefore, if a high resistance device is adopted for the sustain driving circuit in the above-stated structure, it is possible to improve luminous efficiency by increasing the amplitude of the voltage applied to the column electrodes, while restraining cost increase by adoption of the conventional panel structure for the PDP.

In addition, the connection between the column electrodes, the data driving circuit, and the sustain driving circuit is such that when one of the driving circuits is connected to the column electrodes, the other of the driving circuits is disconnected from the column electrodes. Therefore, the output from one of the driving circuits will never enter the other of the driving circuits.

Here, it is preferable to adopt, as a switching unit, a first transfer gate device positioned between the data driving circuit and the column electrodes, and a second transfer gate device positioned between the sustain driving circuit and the column electrodes. This is because a transfer gate device is simple in terms of a circuit structure, and so the cost increase is restrained even when the first and second transfer gate devices adopt a high voltage resistance circuit.

A structure is possible in which, in driving of the above-described PDP apparatus, electrodes of every pair of display electrodes are provided with voltages in pulse waveform that are different in phase by a half period from each other and are the same in length for a High-level time period and a Low-level time period. In this structure, for the purpose of further improving luminous efficiency, it is preferable that the voltage that the sustain driving circuit applies has a pulse waveform that falls when 0.1-0.5 μs has passed after rising of the voltages applied to the electrodes of every pair of display electrodes.

Alternately, it is also possible to adopt a structure of applying, to electrodes of every pair of display electrodes, voltages in pulse waveform that are different in phase by a half period and have a longer High-level time period than a Low-level time period. In this structure, for the purpose of further improving luminous efficiency, it is preferable that the voltage that the sustain driving circuit applies has a pulse waveform that falls within 0.4 μs after falling of the voltages applied to the electrodes of every pair of display electrodes.

Still alternately, it is also possible to adopt a structure of applying, to every pair of display electrodes, voltages in pulse waveform that are different in phase by a half period and have a shorter High-level time period than a Low-level time period. In this structure, for the purpose of further improving luminous efficiency, it is preferable that the voltage that the sustain driving circuit applies has a pulse waveform that falls when 0.2-0.6 μs has passed after falling of the voltages applied to the electrodes of every pair of display electrodes.

### BRIEF DESCRIPTION OF THE DRAWINGS

FIG. 1 is a perspective diagram showing a structure of an PDP relating to the first embodiment.

FIG. 2 is a plan view showing an entire structure of a PDP apparatus relating to the first embodiment.

FIG. 3 is a diagram drawn to explain how each electrode is connected to a driving circuit.

FIG. 4 is a chart showing timing at which voltage is applied, in the sustain period, to scan electrodes, sustain electrodes, data electrodes, and data-sustain electrodes, in the first embodiment.

FIG. 5 is a characteristic diagram showing a relation between falling timing of data-sustain pulse voltage and luminous efficiency.

FIG. 6 is a diagram showing a result of observing discharge size by changing the data-sustain pulse voltage.

FIGS. 7A and 7B are diagrams respectively showing a structure on a back panel 40 of a PDP apparatus relating to the second embodiment.

FIGS. 8A and 8B are diagrams for explaining a difference in interelectrode capacitance between electrode alignment patterns.

FIGS. 9A and 9B are diagrams respectively showing a structure on a back panel of a PDP apparatus relating to the third embodiment.

FIG. 10 is a diagram drawn to explain how each electrode is connected to a driving circuit, in the fourth embodiment.

FIG. 11 is a schematic circuit diagram showing a structure of a general transfer gate device.

FIG. 12 is a chart showing timing at which each driving pulse is applied in the sustain period, in the fourth embodiment.

FIG. 13 is a perspective diagram showing a structure of a PDP that relates to a conventional example.

FIG. 14 is a timing chart for explaining a driving method of a general PDP.

FIG. 15 is a chart showing timing at which voltage is applied, in the sustain period, to scan electrodes, sustain electrodes, and data electrodes in the conventional example.

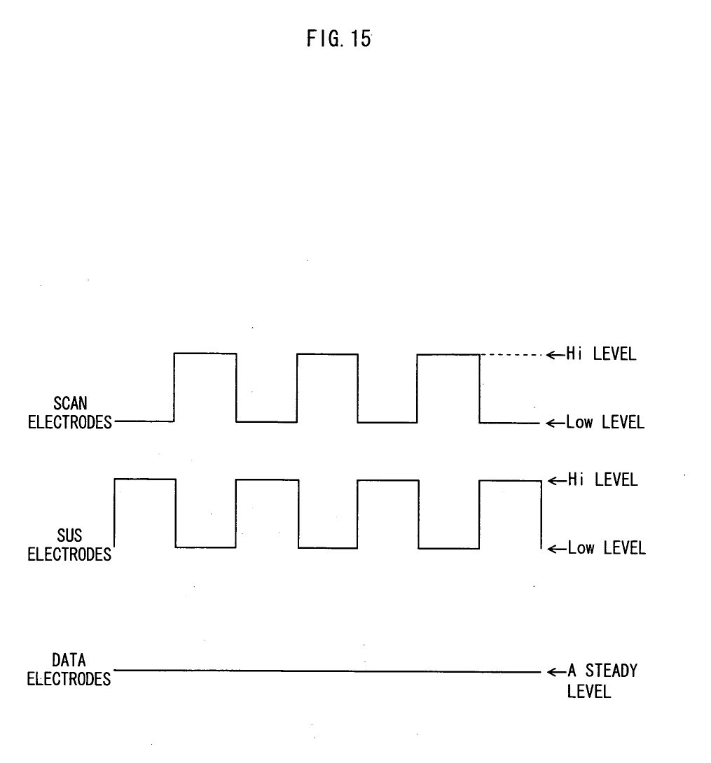

### BEST MODE FOR CARRYING OUT THE INVENTION

The following describes each embodiment of the present invention, with reference to drawings.

### First Embodiment

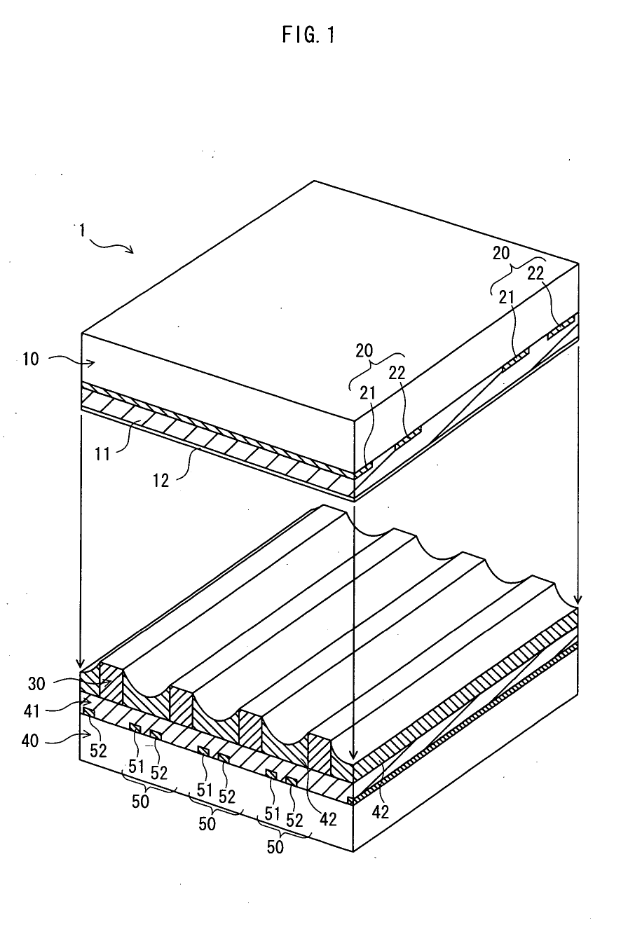

FIG. 1 is a perspective diagram showing a structure of a PDP relating to the first embodiment.

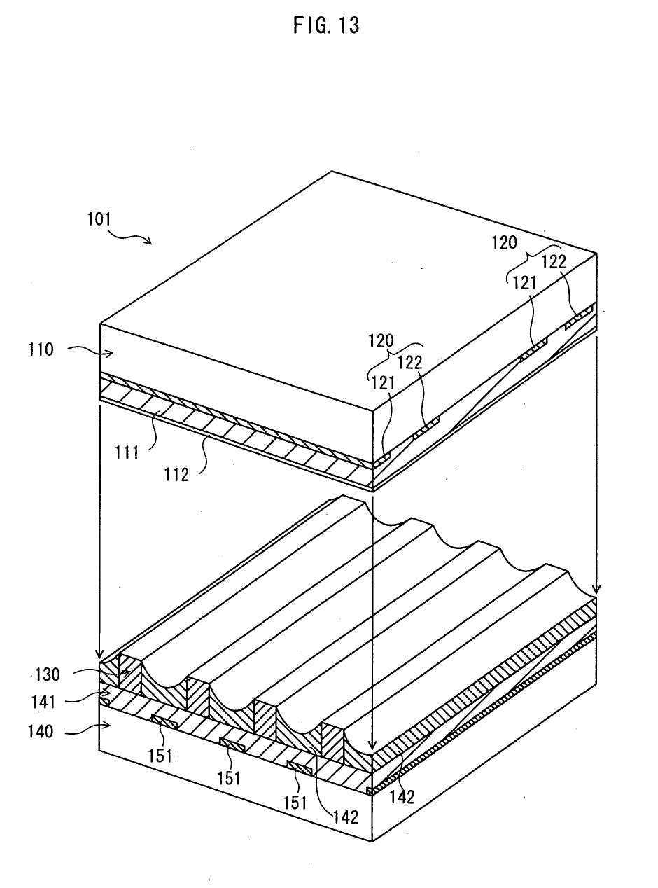

This PDP 1 is different from the conventional PDP shown in FIG. 13, in that the front panel 10 is provided with a plurality of data-sustain electrodes 52, each of which is paired with a corresponding one of the data electrodes 51. For other structures, the PDP 1 is the same as the conventional PDP of FIG. 13.

(Structure of PDP 1)

The PDP 1 has an outer case formed by attaching a front panel 10 and a back panel 40, with barrier ribs 30 formed as gap material therebetween. Besides, the space created between the front panel 10 and the back panel 40 is filled with a discharge gas made of such rare gas as Ne, Xe, and He.

In addition, on the surface (lower surface in FIG. 1) of the front panel 10 that opposes the back panel 40, pairs of display electrodes 20 are arranged parallel to each other, where each pair of display electrodes 20 is composed of a scan electrode 21 and a sustain electrode 22 that extend in a row direction. In addition, a first dielectric film 11 and a protection film 12 are formed with respect to the front panel 110 to cover the pairs of display electrodes 20.

On the surface (upper surface in FIG. 1) of the back panel 40 that opposes the front panel 10, pairs of column electrodes 50 are arranged, where each pair of column electrodes 50 is composed of a data electrode (first column electrode) 51 and a data-sustain electrode (second column electrode) 52 that extend in a column direction. In addition, a second dielectric film 41 is formed with respect to the back panel 40 so as to cover the pairs of column electrodes 50. On the second dielectric film 41, barrier ribs 30 are provided, so that one barrier rib is positioned between two adjacent pairs of column electrodes 50. Moreover on the second dielectric film 41, phosphor layers 42 are provided along the pairs of column electrodes 50, so that one phosphor layer 42 is positioned between two adjacent barrier ribs 30.

Note that the phosphor layers 42 are divided into red, blue, and green phosphor layers, and are arranged so that a red phosphor layer, a blue phosphor layer, and a green phosphor layer appear in repetition.

In the above-described PDP 1, discharge cells are formed where the pairs of display electrodes 20 cross over the data electrodes 51. In other words, the PDP 1 has a structure in which a plurality of discharge cells extend in both column and row directions (i.e. in matrix formation), where the pairs of display electrodes 20 and the pairs of column electrodes 50 oppose each other with the discharge cells therebetween, and the four electrodes face a discharge space.

In each pair of display electrodes 20, the distance between the scan electrode 21 and the sustain electrode 22 is 80 μm, and the height of the barrier ribs 30 is 120 μm, in this example.

If each of the scan electrodes 21 and the sustain electrodes 22 is made to have a structure in which a metal electrode is stacked on a transparent electrode, it is possible to improve light extraction efficiency while reducing electrical resistance.

(Driving Unit and Electrode Connection)

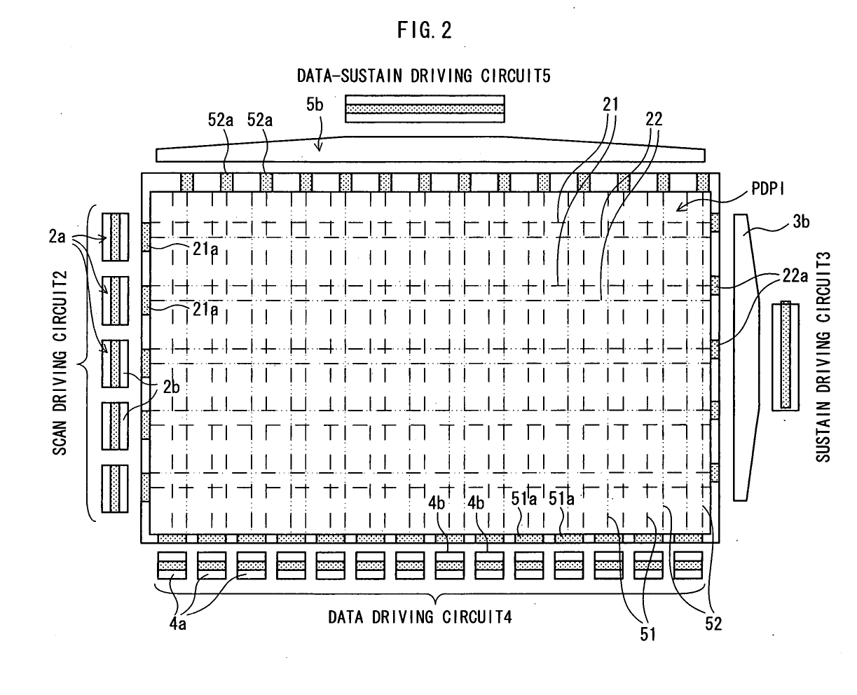

FIG. 2 is a plan view showing an entire structure of a PDP apparatus provided with a driving unit as well as the above-stated PDP 1.

The driving unit of the present PDP apparatus is different from a driving unit of a conventional type, in that it is provided with a data-sustain driving circuit 5 so as to perform data-sustain voltage application to the data-sustain electrodes 52.

Specifically, in the circumferential edge of the PDP 1, input terminals respectively for the electrodes are provided. Driving circuits 2-5 are respectively connected to the input terminals, as detailed below.

Along the left side edge of the PDP 1, input terminals 21a of the scan electrodes 21 are provided. A scan driving circuit 2 is provided with driver devices 2a, and output terminals 2b of the driver devices 2a are connected to the input terminals 21a, respectively. In the write period, this scan driving circuit 2 performs scan pulse application sequentially to the scan electrodes 21 via the driver devices 2a. In the initialization period, the scan driving circuit 2 performs initialization pulse application collectively to the scan electrodes 21. In the same manner, in the sustain period, the scan driving circuit 2 performs sustain pulse application collectively to the scan electrodes 21.

Along the right side edge of the PDP 1, input terminals 22a of the sustain electrodes 22 are provided. An output terminal 3b of a sustain driving circuit 3 is connected to all the input terminals 22a. In the sustain period, the sustain driving circuit 3 performs sustain pulse application collectively to the sustain electrodes 22.

Along the lower side edge of the PDP 1, input terminals 51a of the data electrodes 51 are provided. A data driving circuit 4 is provided with driver devices 4a, and output terminals 4b of the driver devices 4a are connected to the input terminals 51a, respectively. In the write period, this data driving circuit 4 receives input of image data for each subfield line by line, and performs data pulse output selectively to the data electrodes 51 based on the received image data (i.e. applies data pulse to data electrodes 51 selected based on the received image data).

Along the upper side edge of the PDP 1, input terminals 52a of the data-sustain electrodes 52 are provided. An output terminal 5b of a data-sustain driving circuit 5 is connected to all the input terminals 52a. In the sustain period, the data-sustain driving circuit 5 performs data-sustain pulse application collectively to the data-sustain electrodes 52 (i.e. applies data-sustain pulse of a same waveform to all the data-sustain electrodes 52 simultaneously).

Although not shown in the drawing, the driving unit is provided with a control unit for controlling the operation of the driving circuits. The control unit sends different control signals to the driver circuits 2-5 depending on the initialization period, the write period, and the sustain period. Each driving circuit, in turn, operates according to the received signals, thereby adjusting the timing of the whole apparatus.

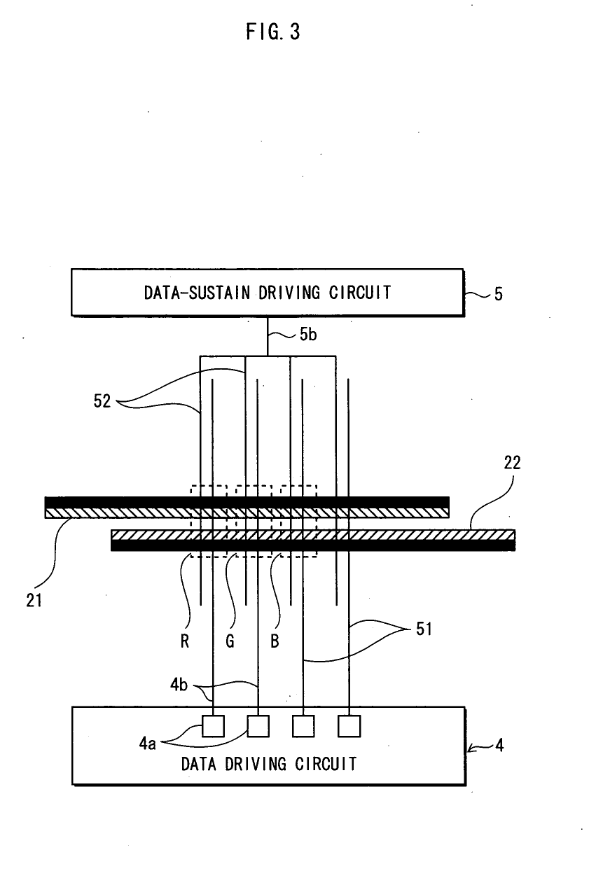

FIG. 3 is a diagram drawn to explain how the electrodes 51 and 52 are connected to the driving circuits 4 and 5, and specifically illustrates apart of the PDP apparatus. In FIG. 3, R, G, and B indicate discharge cells of respective colors, i.e., red, green, and blue phosphor layers are formed in the discharge cells respectively. One pixel is formed by a set of the three discharge cells (R, G, and B).

As shown in this drawing, the data electrodes 51 are independently connected to the driver devices 4a, so as to realize independent data pulse application to each data electrode 51. On the other hand, the data-sustain electrodes 52 are electrically connected to each other before being connected to the data-sustain driving circuit 5, so that the data-sustain driving circuit 5 can perform collective data-sustain pulse application to the whole of the data-sustain electrodes 52.

(Operation of Driving Circuit)

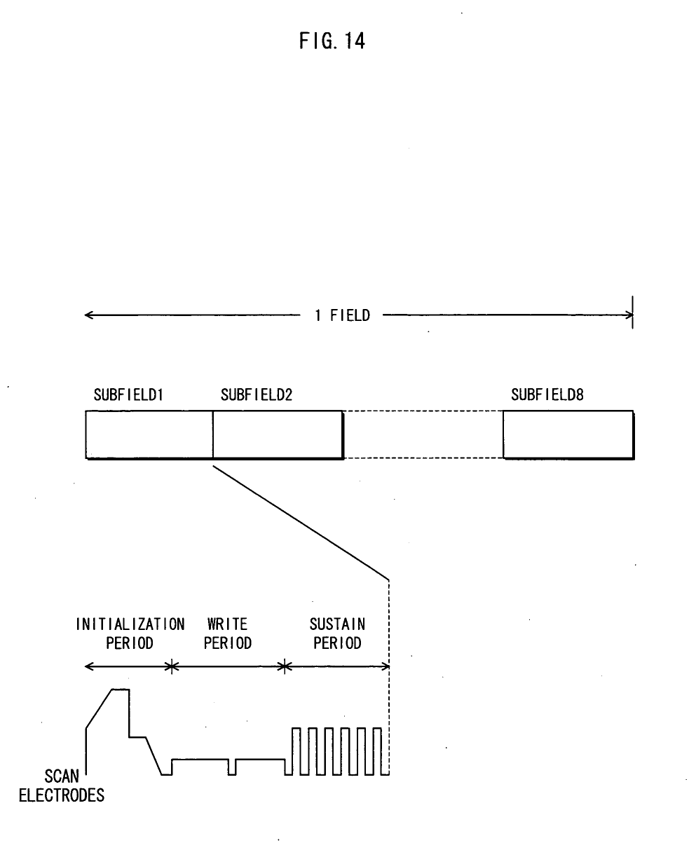

Here, just as in the conventional driving method shown in FIG. 14, one field is divided into a plurality of subfields. Images for the subfields are then chronologically integrated so as to display the field in grayscale. Each subfield includes an initialization period, a write period, and a sustain period.

The operation of the driving unit in the initialization period and the write period directed to each subfield is also the same as in the conventional case. Specifically, in the initialization period, the scan driving circuit 2 performs initialization pulse application to the entire scan electrodes 21, and generates initialization discharge in all the discharge cells, thereby removing effect of the prior subfield, performing absorption of variation in discharge characteristics, and the like. In the write period, the scan driving circuit 2 performs scan pulse application sequentially to the scan electrodes 21, and the data driving circuit 4 performs data pulse application selectively to the data electrodes 51 based on inputted image data, thereby generating write discharge in discharge cells to be illuminated and forming wall charge on the surface of the protection film 12 positioned on the scan electrodes 21 and the sustain electrodes 22.

On the other hand, the operation in the sustain period is different from the operation of the conventional example. In the present embodiment, the scan driving circuit 2 and the sustain driving circuit 3 perform collective sustain pulse application to the scan electrodes 21 and the sustain electrodes 22, respectively. In addition, the data-sustain driving circuit 5 performs collective data-sustain pulse application to the data-sustain electrodes 52.

Note that each discharge cell faces one data electrode 51 and one data-sustain electrode 52. According to this structure, it becomes possible to apply data-sustain pulses to the discharge cells evenly with little loss.

The following details the operation performed in the sustain period.

(Operation in Sustain Period)

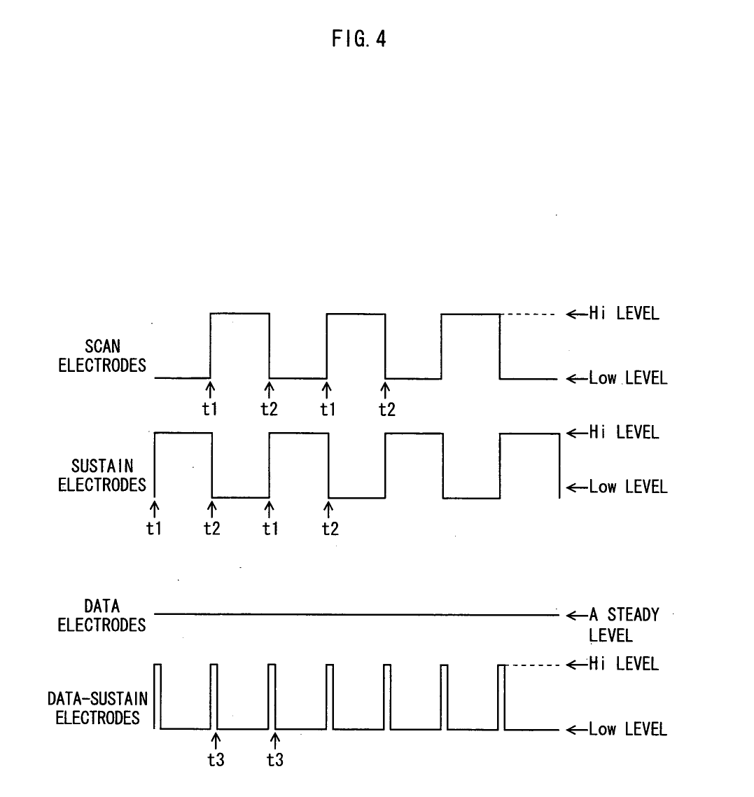

FIG. 4 is a timing chart showing timing at which voltage is applied to the scan electrodes 21, the sustain electrodes 22, the data electrodes 51, and the data-sustain electrodes 52, in the sustain period.

As shown in this drawing, in the sustain period, the scan driving circuit 2 and the sustain driving circuit 3 perform positive sustain pulse application to the scan electrodes 21 and the sustain electrodes 22, collectively at certain intervals. As a result, each of the electrodes 21 and 22 will exhibit a High-level of voltage waveform from the rising point t1 to the falling point t2 of the sustain pulse, and exhibit a Low-level of voltage waveform from the falling point t2 to the rising point t1 of the sustain pulse. The High-level and the Low-level will alternate repetitively. Here, it should be noted that the sustain voltages respectively applied to the electrodes 21 and the electrodes 22 are set so that the phases thereof deviate from each other by a half period.

For this sustain voltage, it is possible to set the same amount of time (e.g. 2.5 μsec) for each of the High level and the Low level. Alternatively, it is possible to set different amounts of time between the High level and the Low level. Note that in the former case, the sustain-pulse rising point t1 of one of the electrodes 21 and 22 coincides with the sustain-pulse falling point t2 of the other of the electrodes 21 and 22. However in the latter case, they will deviate from each other.

The data driving circuit 4 sustains the entire data electrodes 51 to a steady Low level of potential.

The data-sustain driving circuit 5 performs positive data-sustain pulse application to the data-sustain electrodes 51 collectively and in synchronization with the sustain pulse application stated above. This data-sustain pulse is applied so that the High level will appear in a shorter time than the High level of the sustain pulse.

After the above-stated process, the discharge cells, in which write discharge is generated in the write period, will undergo sustain discharge thereby illuminating.

Suppose the above-stated case of performing, in the sustain period, data-sustain pulse application to the data-sustain electrodes 52, in synchronization with the sustain pulse application applied to the scan electrodes 21 and the sustain electrodes 22. In this case, the luminous efficiency will improve if the voltage amplitude for the data-sustain pulse is set large. This is considered attributable to the fact that when the data-sustain pulse is set to have a larger voltage amplitude, the discharge cells undergo longer sustain discharge and the discharge approaches nearer to the phosphor layers 42, as can be understood by the later detailed experiment.

In summary, it is possible to improve the luminous efficiency largely, if adopting a data-sustain driving circuit 5 of a high resistance such as above 80V thereby setting the voltage amplitude to be applied to the data-sustain electrodes 52 to be high.

### Advantage of PDP Apparatus of the Present Embodiment

The data-sustain circuit 5 mainly performs data-sustain pulse application to the data-sustain electrodes 52 collectively, and so the number of output terminal 5b can be small. Indeed, it is sufficient that there is at least one output terminal 5b, and accordingly, the semiconductor chip constituting the data-sustain driving circuit 5 can have a comparatively simple structure. Therefore, if the driver device of the data-sustain driving circuit 5 is of a high voltage resistance (above 80V) as described above, the cost will not rise so much.

As explained so far, according to the present PDP apparatus, the luminous efficiency improves by increasing the voltage amplitude of the data-sustain pulse, while restraining the cost increase.

If a conventional type of PDP is equipped with a high voltage resistance driver device in its data driving circuit, it is also possible to increase the voltage amplitude of the data-sustain pulse to be applied to the data electrodes 151 thereby largely improving the luminous efficiency.

However, as stated above, the data driving circuit has to have a function of performing data pulse application selectively to the data electrodes 151 based on inputted image data. In view of this, a plurality of driver devices become necessary so as to realize independent application of data pulse to each data electrode 151. Accordingly, the circuit structure of the data driving circuit is complicated.

For example, for a HD type (1366 pixels×768 pixels), the number of scan electrodes is 768, and the number of data electrodes is 1366×3=4098. In this case, the number of necessary driver devices for the data driving circuit is 43, assuming that each driver device has 96 output.

Accordingly, if a driver device of the data driving circuit is of a high voltage resistance, the cost will rise considerably. Therefore, the practical resistance of the device usable as the data driving circuit remains at about 80V.

(Relation among Voltage Amplitude, Falling Timing of Data-Sustain Pulse, and Luminous Efficiency)

The following experiments were conducted so as to confirm that in a PDP it is advantageous to have large amplitude of data-sustain voltage for obtaining more improved luminous efficiency.

### EXPERIMENT 1

The experiment 1 was conducted by setting the voltage amplitude of the data-sustain pulse to 80V and to 150V. In both cases, by changing the falling point of the data-sustain pulse with respect to the rising point of the sustain pulse, a PDP was actually illuminated and the quantity of light emission was measured. Then luminous efficiency was obtained using the measurement result.

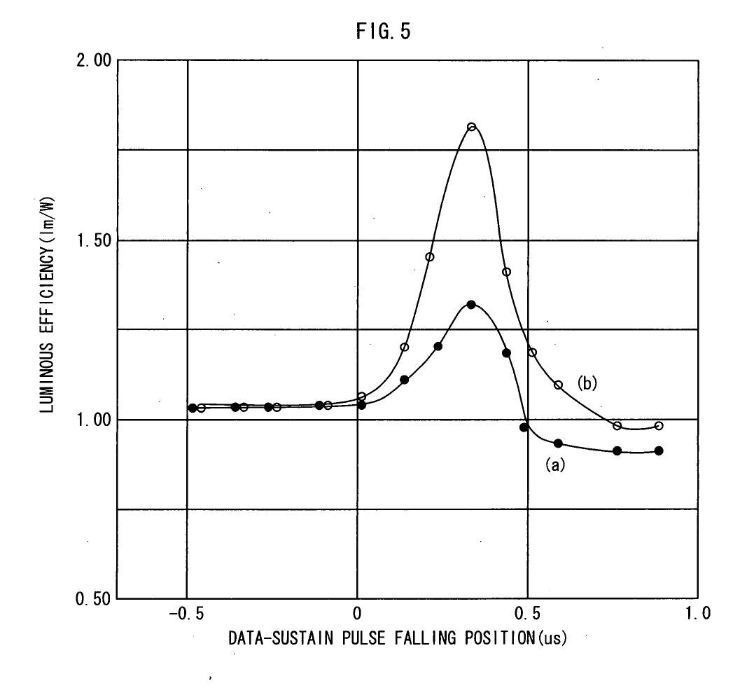

FIG. 5 shows the result, which plots the relation between the falling point and the luminous efficiency. In FIG. 5, the plot (a) shows values in a case where the data-sustain pulse voltage is 80V, and the plot (b) shows values in a case where the data-sustain pulse voltage is 150V.

Each plot exhibits its maximum luminous efficiency when the falling point of the data-sustain pulse is at 0.3 μs from the rising point of the sustain pulse. In the case where the data-sustain pulse has the voltage amplitude of 80V, the luminous efficiency is 1.3 lm/W, whereas in the case where the data-sustain pulse has the voltage amplitude of 150V, the luminous efficiency is 1.8 lm/W.

From the results, it has been confirmed that the luminous efficiency has improved greatly by increasing the data-sustain pulse voltage to be applied in the sustain period from 80V to 150V.

### EXPERIMENT 2

sustain discharge was conducted in each following condition, and the discharge size was observed from a sectional direction.

<Condition A> Conducting sustain discharge without application of voltage to the data-sustain electrodes in the sustain period.

<Condition B> Conducting sustain discharge by applying data-sustain pulse having the voltage amplitude of 80V to the data-sustain electrodes at the timing of generation of maximum luminous efficiency.

<Condition C> Conducting sustain discharge by applying data-sustain pulse having the voltage amplitude of 150V to the data-sustain electrodes at the timing of generation of maximum luminous efficiency.

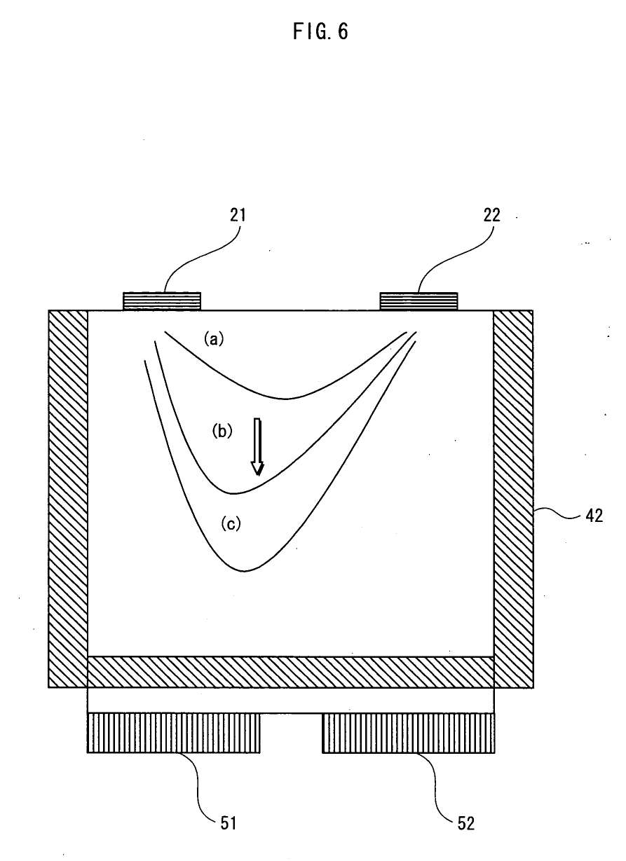

FIG. 6 is a diagram schematically showing the result.

FIG. 6 indicates the following:

(a) at normal discharge, the discharge pattern indicates a short arc form;

(b) if data-sustain pulses are applied to the data-sustain electrodes, the discharge becomes longer and the discharge approaches nearer to the phosphor layer 42; and

(c) if the voltage amplitude of the data-sustain pulse is made to be large as in the condition C, the discharge becomes still longer and the discharge approaches much nearer to the phosphor layer 42.

In this way, it has been confirmed that as the increase in the voltage amplitude of the data-sustain pulse, the discharge becomes longer, indicating increase in the quantity of discharge, and that the discharge approaches nearer to the phosphor layer. It is considered that luminous efficiency is improved because of them.

As can be understood by FIG. 5 explained above, the falling point of the data-sustain pulse also affects the improvement in luminous efficiency. In view of this, an experiment was also conducted in which falling point of the data-sustain pulse is changed.

The result shows that for achieving higher luminous efficiency, it is effective to set the falling point t3 of the data-sustain pulse to be applied to the data-sustain electrode 52 to be at 0.1-0.5 μs (preferably at 0.2-0.4 μs) after the rising point t1 of the sustain pulse, in the case where voltages in pulse waveform that are different in phase by a half period from each other and are the same in length for a High-level time period and a Low-level time period are applied to the scan electrodes 21 and the sustain electrodes 22, respectively.

On the other hand, in the case where the scan electrodes 21 and the sustain electrodes 22 are provided with voltages in pulse waveform in which the High level time period is longer than the Low level time period, and that the phases thereof are different by a half period, it is effective to set the falling point t3 of the data-sustain pulse to be within 0.4 μs from the falling point t2 of the sustain pulse for obtaining higher luminous efficiency.

Furthermore, in the case where the scan electrodes 21 and the sustain electrodes 22 are provided with voltages in pulse waveform in which the High level time period is shorter than the Low level time period, and that the phases thereof are different by a half period, it is effective to set the falling point t3 of the data-sustain pulse to be at 0.2-0.6 μs after the falling point t2 of the sustain pulse for obtaining higher luminous efficiency.

### MODIFICATION EXAMPLE REGARDING DATA-SUSTAIN ELECTRODE AND DATA-SUSTAIN PULSE

(1) In the PDP 1, the form of each data-sustain electrode 52 may be uniform. However, it is also possible to change the form of the data-sustain electrodes 52 for each of the colors of the phosphor layers.

For example, when illuminated under the same condition, the blue cells tend to have low luminous intensity while the red cells tend to have high luminous intensity. This means that it is possible to adjust white balance by changing the electrodes' form so that data-sustain electrodes 52 that correspond to the red phosphor layers have small discharge size, and that data-sustain electrodes 52 that correspond to the blue phosphor layers have large discharge size.

Specifically the following arrangement can be made. The data-sustain electrodes 52 that correspond to the blue phosphor layers are set to be wide in electrode width, to increase the electrode size that faces the blue cells, and the data-sustain electrodes 52 that correspond to the red phosphor layers are set to be narrow in electrode width, to decrease the electrode size that faces the red cells.
(2) In the above description, in the PDP 1, the data-sustain electrodes 52 are made to undergo collective data-sustain pulse application. However, it is also possible to provide different driver devices and output terminals of the data-sustain driving circuit 5 that applies pulses to the data-sustain electrodes 52, depending on each of the colors of the phosphor layers, for the purpose of changing the form of the data-sustain pulses.

Specifically, the following arrangement can be made for example. The data-sustain driving circuit 5 is provided with a blue driver device, a green driver device; and a red driver device. The blue driver device is connected to data-sustain electrodes 52 corresponding to the blue phosphor layers, thereby enabling application of data-sustain voltage having a large voltage amplitude so as to obtain a large discharge size. The red driver device is connected to data-sustain electrodes 52 corresponding to the red phosphor layers, thereby enabling application of data-sustain voltage having a small voltage amplitude so as to obtain a small discharge size. This arrangement enables white balance to be adjusted.

### Second Embodiment

A PDP apparatus of the present embodiment has a similar structure to the PDP of the above-described first embodiment. However in the PDP apparatus of the present embodiment, the alignment of the data electrodes 51 and the data-sustain electrodes 52 are different from that of the first embodiment.

The plan view of the entire PDP apparatus relating to the present embodiment is the same as shown in FIG. 2 explained above. The circumferential edge of the PDP1 is provided with input terminals for the electrodes, and driving circuits 2-5 are connected to these input terminals.

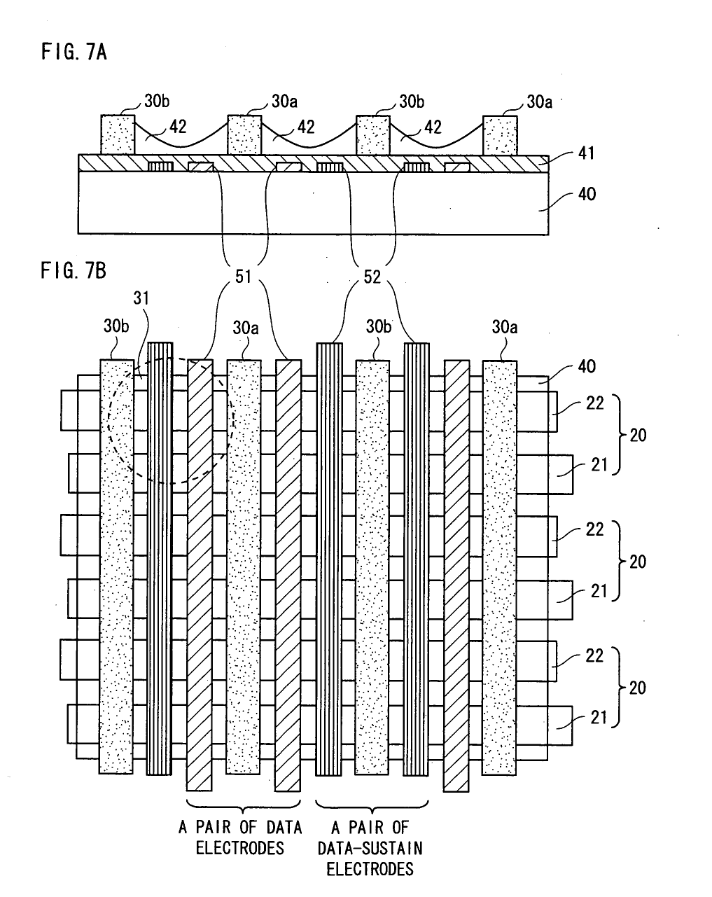

FIGS. 7A and 7B are diagrams respectively showing a structure on the back panel 40 of the PDP apparatus relating to the second embodiment. FIG. 7A is a sectional diagram in which the back panel 40 is cut along the row direction, and FIG. 7B is a plan view showing the appearance on the back panel 40. It should be noted that in FIG. 7B, the position of the pairs of display electrodes 20 (scan electrodes 21 and sustain electrodes 22) is also illustrated to clarify the positional relation between the electrodes.

In the drawings, the reference numeral 31 (corresponding to an area surrounded by a dotted circle) indicates one discharge cell.

Here, a plurality of data electrodes 51 and a plurality of data-sustain electrodes 52 extend parallel to each other. The present embodiment is the same as the first embodiment in that, in each discharge cell, a pair of display electrodes 20 and a pair of column electrodes 50 are arranged to face each other, so that the four electrodes face the discharge cell. However the present embodiment is different from the first embodiment in how the electrodes are aligned.

In the first embodiment, the data electrodes 51 and the data-sustain electrodes 52 are aligned alternately in the column direction. On the other hand, in the present embodiment, the pairs of data electrodes are formed by arranging each two data electrodes 51 adjacent to each other, unlike in the first embodiment.

More specifically, the pairs of data electrodes are formed in such a manner that each of barrier ribs 30a, which is selected alternately from the barrier ribs 30, is sandwiched with two data electrodes 51. One of the two data electrodes 51 faces a column of discharge cells that extends along one side of the barrier rib 30a, and the other of the two data electrodes 51 faces an adjacent column of discharge cells (i.e. a column of discharge cells that extends along the other side of the barrier rib 30a).

In other words, the pairs of data electrodes are aligned in such a pattern that pairs of data electrodes, each of which is made of two adjacent data electrodes 51, are aligned alternately with pairs of data-sustain electrodes, each of which is made of two adjacent data-sustain electrodes 52.

Please note that the present embodiment is the same as the first embodiment in that each discharge cell faces one data electrode 51 and one data-sustain electrode 52, which enables application of data-sustain pulses to the discharge cells evenly with little loss.

The driving operation of the PDP apparatus is the same as described above in the first embodiment with reference to FIG. 4. Specifically, in the sustain period, pulse voltages are applied to the scan electrodes 21 and the sustain electrodes 22 respectively, so that the phases thereof deviate from each other by a half period, the data electrodes 51 are made to receive a certain Low level potential, and the data-sustain electrodes 52 are provided with a pulse voltage that rises at a timing of changing in scanning pulse voltage. Here, the rising timing t2 of each data-sustain pulse is controlled so as to generate the maximum intensity.

### Advantage of the Present Embodiment

The present embodiment shares the same basic advantage as that of the first embodiment, namely, improvement of luminous efficiency by increasing the voltage amplitude of the data-sustain pulses while restraining the cost increase. In addition to this advantage, the present embodiment has another advantage of reducing reactive power during the sustain period because of smaller coupling capacitance between the data electrodes 51 and the data-sustain electrodes 52 than in the first embodiment.

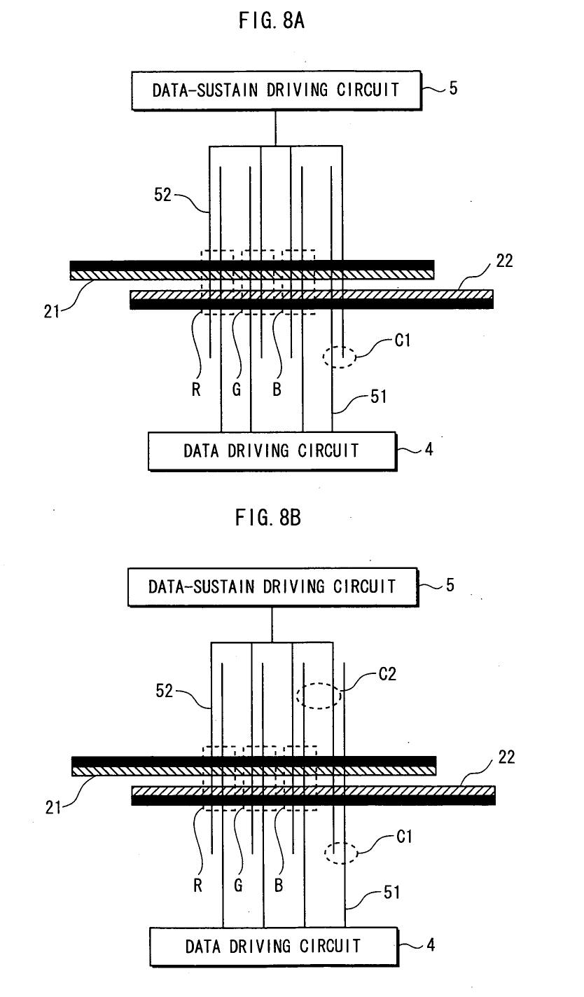

FIGS. 8A and 8B are diagrams for explaining the difference in interelectrode capacitance between electrode alignment patterns. FIG. 8A illustrates an electrode alignment pattern in which pairs of data electrodes 51 and pairs of data-sustain electrodes 52 alternate, and FIG. 8B illustrates an electrode alignment pattern in which data electrodes 51 and data-sustain electrodes 52 alternate as in the first embodiment.

Here, suppose that a coupling capacitance between adjacent electrodes within discharge cells belonging to the same column is C1, and that a coupling capacitance between adjacent electrodes between two discharge cells that respectively belong to two adjacent columns is C2. Under this supposition, total coupling capacitance for each electrode alignment pattern is compared. In each electrode alignment pattern, a data electrode 51 and a data-sustain electrode 52 are adjacent to each other in the discharge cells belonging to the same column. However, In the case of FIG. 8B, a data electrode 51 and a data-sustain electrode 52 are arranged to be adjacent between discharge cells respectively belonging to two adjacent columns. In the case of FIG. 8B, the total coupling capacitance corresponds to a summation of the coupling capacitance C1 and the coupling capacitance C2 (i.e. the total coupling capacitance being “C1+C2”).

In the case of FIG. 8A, however, between discharge cells respectively belonging to two adjacent columns, electrodes of a same kind are arranged to be adjacent. Specifically, with respect to a data electrode 51, a data electrode 51 facing a discharge cell belonging to an adjacent column is adjacent. On the other hand, with respect to a data-sustain electrode 52, a data-sustain electrode 52 facing a discharge cell belonging to an adjacent column is adjacent. In the sustain period, all the data electrodes 51 are maintained to a certain level of potential, and collective voltage application is performed to all the data-sustain electrodes 52. Accordingly, where there are two adjacent electrodes of a same type, charge and discharge of electric charge do not occur. In view of this, it is possible to equivalently consider C2=0. Therefore the total coupling capacitance corresponds to C1.

The coupling capacitances C1 and C2 were measured by conducting experiments using PDPs manufactured based on the present embodiment. As a result, the coupling capacitance C1 is about 100 nF, and the coupling capacitance C2 is about 60 nF. Therefore in the electrode alignment pattern of FIG. 8A, the total coupling capacitance will be about 100 nF, however in the electrode alignment pattern of FIG. 8B, the total coupling capacitance will be about 160 nF.

Note that the alignment pattern shown in FIGS. 7A and 7B (i.e. an alignment pattern in which pairs of data electrodes and pairs of data-sustain electrodes alternate) may be employed partially on the back panel 40. However, the effect of reducing reactive power during the sustain period is substantially proportional to the number of data electrodes 51 forming the pair of data electrodes. Therefore it is preferable to adopt the alignment pattern of FIGS. 7A and 7B throughout the back panel 40 for the purpose of enhancing the effect of reducing reactive power during the sustain period.

### Third Embodiment

A PDP apparatus relating to the present embodiment has a similar structure to the PDP of the above-described second embodiment, except for a difference in pattern and arrangement of the data-sustain electrodes 52 in the PDP 1.

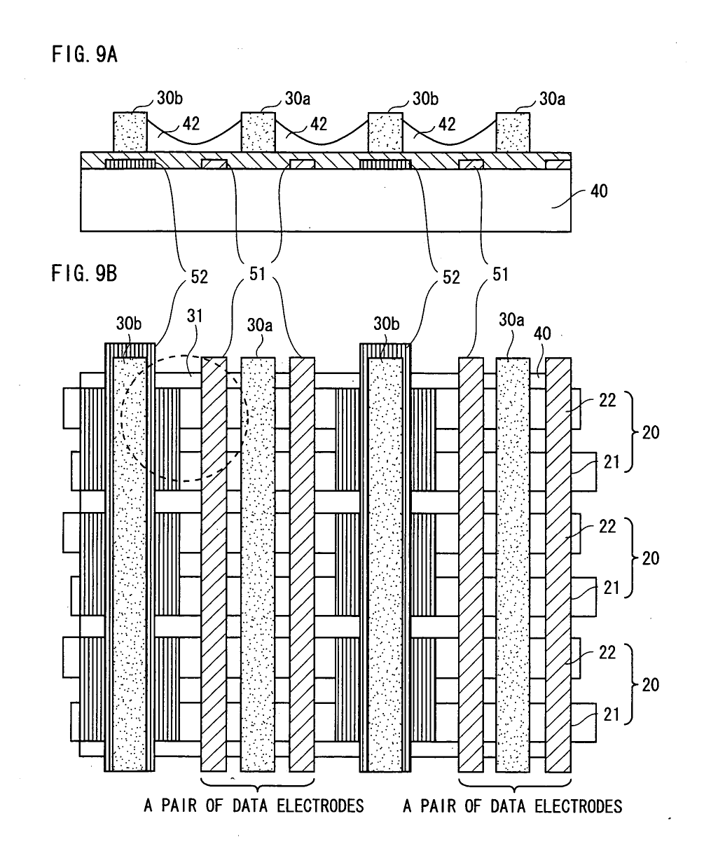

FIGS. 9A and 9B are diagrams respectively showing a structure on a back panel of the PDP apparatus relating to the present embodiment. FIG. 9A is a sectional diagram in which the back panel 40 is cut along the row direction, and FIG. 9B is a plan view showing the appearance on the back panel 40.

As shown in FIGS. 9A and 9B, each barrier rib 30a is sandwiched between two data electrodes 51 arranged adjacent to each other, to form the pairs of data electrodes, just as in the second embodiment. However in the above-described second embodiment, a pair of data-sustain electrodes 52 are arranged adjacent to each other by sandwiching a barrier rib 30b. As opposed to this, in the present embodiment, one data-sustain electrode 52 that is provided along a barrier rib 30b, corresponding to an odd-numbered barrier rib. Here, the data-sustain electrode 52 is wider than the barrier rib 30b.

In other words, the number of data-sustain electrodes 52 in the present embodiment is half the number of the counterpart in the second embodiment. However, each data-sustain electrode 52 faces both of discharge cells respectively belonging to two adjacent columns. Therefore it is possible to perform simultaneous voltage application to the discharge cells belonging to the two columns and positioned in both sides of the odd-numbered barrier rib 30b.

Therefore, the present embodiment has a structure in which four electrodes (a pair of display electrodes 20, a data electrode 51, and a data-sustain electrode 52) face a discharge cell 31, just as in the first and second embodiments, thereby enabling application of data-sustain voltages to the discharge cells evenly with little loss.

With the PDP apparatus of the third embodiment, it is possible to obtain an advantage similar to those of the second embodiment described above. Namely, luminous efficiency is improved by increase in the voltage amplitude of the data-sustain pulses while restraining the cost increase. In addition to the above-stated basic advantage, the PDP apparatus of the third embodiment has an advantage of reducing reactive power during the sustain period because of smaller coupling capacitance between the data electrodes 51 and the data-sustain electrodes 52.

Still further, the present embodiment is advantageous in realizing high definition display by decreasing size of discharge cells, because the number of the data-sustain electrodes 52 is half the counterpart of the second embodiment.

Note that the alignment pattern shown in FIGS. 9A and 9B (i.e. an alignment pattern in which pairs of data electrodes and data-sustain electrodes alternate) may be employed partially on the back panel 40. However, the effect of reducing reactive power during the sustain period is substantially proportional to the number of data electrodes 51 forming the pair of data electrodes. Therefore it is preferable to adopt the alignment pattern of FIGS. 9A and 9B throughout the back panel 40 for the purpose of enhancing the effect of reducing reactive power during the sustain period.

### Fourth Embodiment

In the PDP 1 of the first to third embodiments, two kinds of electrodes are provided on the back panel 40 that extend in the column direction: data electrodes 51 and data-sustain electrodes 52. However the panel structure of the PDP relating to the present embodiment is the same as that in the conventional PDP shown in FIG. 13. Namely, the back panel 40 is only provided with data electrodes 51 thereon, without data-sustain electrodes 52.

With regard to the driving unit, the PDP 1 of the present embodiment is provided with a scan driving circuit 2, a sustain driving circuit 3, a data driving circuit 4, and a data-sustain driving circuit 5, in the same way as shown in FIG. 2. A plurality of output terminals for the scan driving circuit 2 are connected to electrodes of the scan electrodes 21, respectively. An output terminal of the sustain driving circuit 3 is connected to all the sustain electrodes 22.

In the first embodiment, the output terminals of the data driving circuit 4 and the output terminal of the data-sustain driving circuit 5 are connected to the data electrodes 51 and the data-sustain electrodes 52, respectively. However in the present embodiment, as detailed later, the output terminals of the data driving circuit 4 and the output terminal of the data-sustain circuit 5 are connected to be switchable to the data electrode 51 between the write period and the sustain period.

In the present embodiment, the operation of the driving unit is the same in the initialization period and in the write period, as in the first embodiment. Namely, each of electrodes 21, 22, and 51 undergoes a driving pulse application, thereby causing a write discharge to occur in each discharge cell to be illuminated.

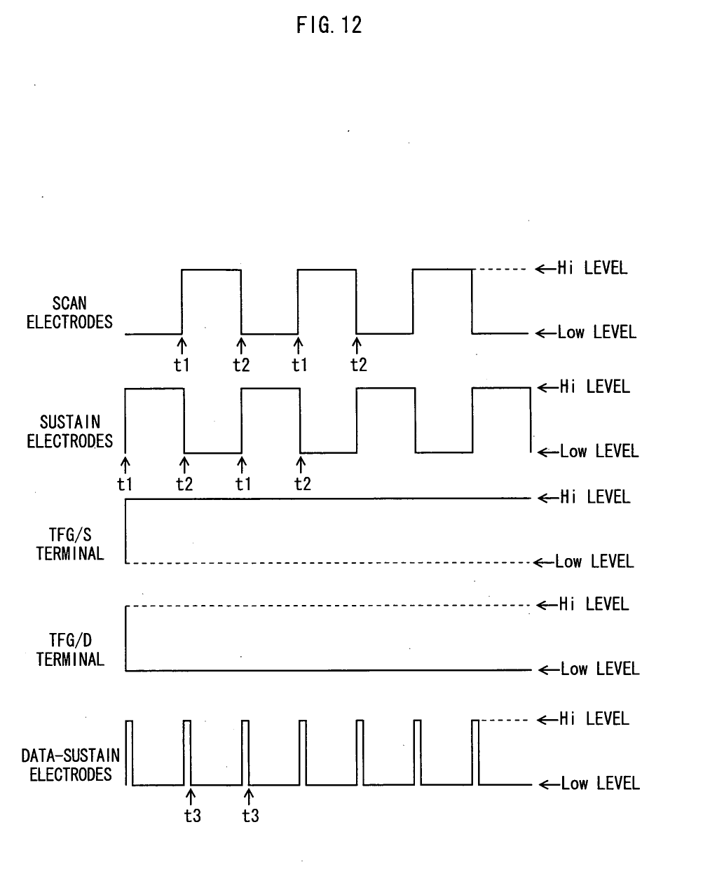

The operation of the driving circuit in the sustain period is also the same as described in the first embodiment. Specifically, as shown in FIG. 12, the scan driving circuit 2 and the sustain driving circuit 3 perform sustain pulse application at certain intervals to the scan electrodes 21 and the sustain electrodes 22 (i.e. applied voltage has a waveform having the High-level time period and the Low-level time period appearing alternately and repetitively, and the phases for the scan electrodes 21 and the sustain electrodes 22 will deviate from each other by a half period). Meanwhile, the data-sustain driving circuit 5 performs pulse application to the data electrodes 51 in synchronization with the sustain pulses applied to the scan electrodes 21 and the sustain electrodes 22. As a result, the discharge cells, in which write discharge is generated in the write period, will undergo sustain discharge thereby illuminating. As explained in the first embodiment, if the data-sustain driving circuit 5 adopts a high resistance circuit such as above 80V, thereby setting the voltage amplitude to be applied to the data-sustain electrodes 52 to high, the luminous efficiency will improve largely.

(Switchable Connection Structure between Data Driving Circuit 4 and Data-Sustain Driving Circuit 5 with Respect to Data Electrodes 51)

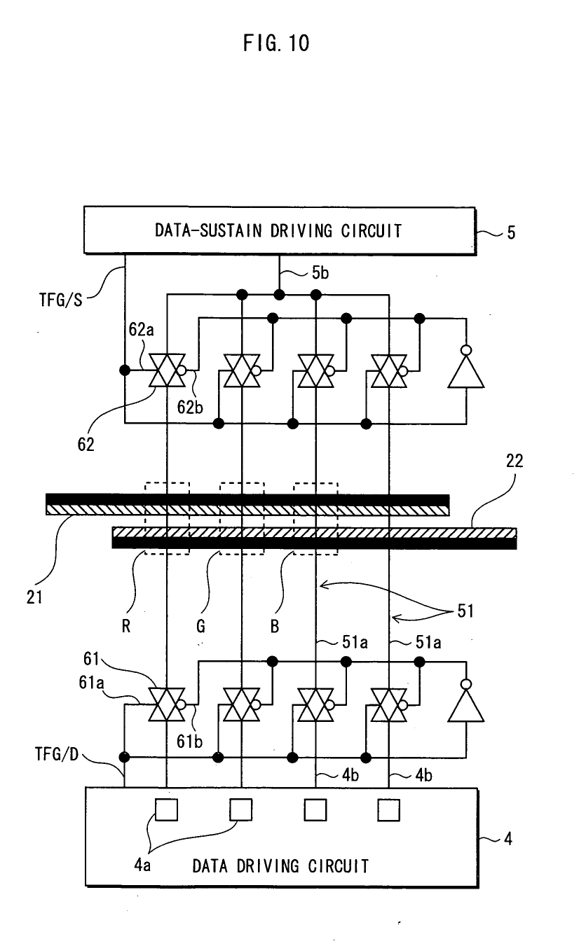

FIG. 10 is a diagram drawn to explain how the data electrodes 51 are connected to the driving circuits 4 and 5 in the present embodiment, which specifically illustrates a part of the PDP apparatus. Note that R, G, and B in FIG. 10 indicate discharge cells in which red, green, blue phosphor layers are respectively formed.

As shown in this drawing, input terminals 51a of the data electrodes 51 are respectively connected to output terminals 4b of the data driving circuit 4 via first transfer gate devices 61, where the first transfer gate devices 61 respectively function. as an analogue switch. In addition, input terminals 51b of the data electrodes 51 are collectively connected to the output terminal 5b via second transfer gate devices 62, where the second transfer gate devices 62 respectively function as an analogue switch.

In the write period, the first transfer gate devices 61 are set ON, to get ready for voltage application from the data driving circuit 4 to the data electrodes 51, and the second transfer gate devices 62 are set OFF thereby electrically disconnecting the data electrodes 51 from the data driving circuit 5.

On the contrary, in the sustain period, the second transfer gate devices 62 are set ON, to get ready for voltage application from the data driving circuit 5 to the data electrodes 51, and the first transfer gate devices 61 are set OFF thereby electrically disconnecting the data electrodes 51 from the data driving circuit 4.

Note that if the data-sustain driving circuit 5 is structured by a semiconductor chip, the second transfer gate devices 62 may be incorporated into the semiconductor chip.

In this way, by operating the transfer gate devices 61 and 62, it becomes possible to perform voltage application to the data electrodes 51 from the data driving circuit 4 at one time, and from the data driving circuit 5 at another time.

This is further detailed by referring to FIGS. 10, 11, and 12.

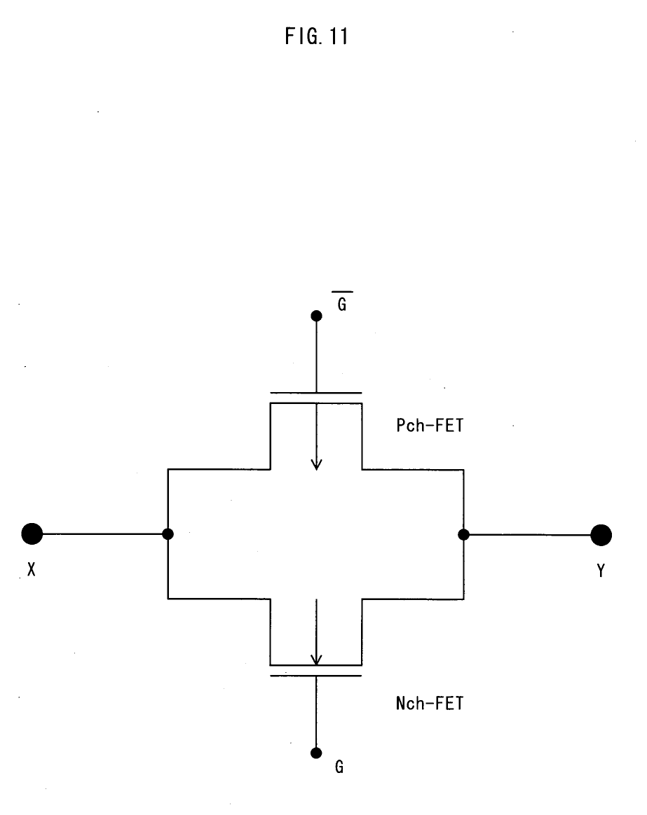

FIG. 11 is a diagram showing a structure of a general transfer gate device.

FIG. 12 is a timing chart showing timing at which voltage application is performed respectively to the scan electrodes 21, the sustain electrodes 22, the data electrodes 51, the data-sustain electrodes 52, a TFG/S terminal, a TFG/D terminal, in the sustain period.

As shown in FIG. 11, the transfer gate device has a structure in which an N-channel FET and an P-channel FET are connected in parallel between the input/output terminals X and Y. When switch control pulses, which are inverse of each other, are applied to the N-channel FET's gate electrode and the P-channel FET's gate electrode, the input/output terminals-X and Y are to be brought in connection to each other (i. e. brought to ON state).

The first transfer gate devices 61 and the second transfer gate devices 62 adopt such a transfer gate device.

In addition, as shown in FIG. 10, the data driving circuit 4 is equipped with a TFG/D terminal so as to control open/close of the first transfer gate devices 61. The voltage outputted from the TFG/D terminal is applied to the gate terminal 61a of the first transfer gate devices 61. In addition, a pulse reverse of the above-stated voltage is designed to be applied to the gate terminal 61b. In addition, the data-sustain driving circuit 5 is equipped with a TFG/S terminal so as to control open/close of the second transfer gate devices 62. The voltage outputted from the TFG/S terminal is applied to the gate terminal 62a. In addition, a pulse reverse of the above-stated voltage is designed to be applied to the gate terminal 62b.

The data driving circuit 4 switches the voltage of the TFG/S terminal to High level in the write period, and to Low level in the sustain period, in accordance with control signals from the control unit. On the other hand, the data-sustain driving circuit 5 switches the voltage of the TFG/D terminal to Low level in the write period, and to High level in the sustain period, in accordance with control signals from the control unit (See FIG. 12).

According to the above-described operation, in the write period, data voltage application is performed selectively to the data electrodes 51 from the output terminals 4b of the data driving circuit 4 (See FIG. 12). At the same time, the data electrodes 51 are disconnected from the data-sustain circuit 5. Accordingly, the output from the data electrodes 51 will not enter the data-sustain driving circuit 5. On the other hand, in the sustain period, collective sustaining data voltage application is performed to the entire data electrodes 51 from the data-sustain driving circuit 5. At the same time, the data electrodes 51 are disconnected from the data driving circuit 4. Accordingly, the output from the data electrodes 51 will not enter the data driving circuit 5.

### Advantages of the PDP of the Present Embodiment

In the PDP apparatus of the present embodiment, if the data-sustain driving circuit 5, the first transfer gate devices 61, and the second transfer gate devices 62 are endowed with a high voltage resistance, it is possible to increase the voltage amplitude of the data-sustain voltage to be applied to the data electrodes thereby largely improving the luminous efficiency, and to perform the above operation stably. This is realized, for example by a structure in which the voltage resistance of the data driving circuit 4 is 80V, and the first transfer gate devices 61 and the second transfer gate devices 62 are of a voltage resistance of 300V.

Here, the data-sustain driving circuit 5 and the transfer gate devices 61 and 62 have a simple circuit structure, and so if a high voltage resistance circuit is adopted therefor, the cost will not rise so much.

Therefore, with the PDP apparatus of the present embodiment too, luminous efficiency is improved by increasing the voltage amplitude of the data-sustain pulses while restraining the cost increase.

Experiments were conducted for the PDP apparatus of the present embodiment, too, to see how the luminous efficiency changes according to change in voltage-amplitude of the data-sustain pulse and in falling point of the data-sustain pulse. The obtained result was the same as explained in the first embodiment. Therefore, as described earlier, it can be said that it is effective, for the purpose of obtaining high luminous efficiency, to set the falling point t3 of the data-sustain pulse to be applied to the data electrodes 51, within a certain range either from the rising point t1 or from the falling point t2 of the sustain pulse applied to the scan electrodes 21 and the sustain electrodes 22.

### Modification Examples and so Forth Regarding the Embodiments

In the above description, a plurality of pairs of display electrodes are provided on the front panel. However, if the front panel is provided with at least one pair of display electrodes, it is sufficient for carrying out the present invention.

In the above description, in the sustain period, the data-sustain driving circuit 5 is explained to apply data-sustain pulses. However, the voltage that the data-sustain driving circuit 5 applies in the sustain period is not limited in the form of pulse. For example, the present invention may be carried out if a certain voltage is continuously applied throughout the sustain period, and luminous efficiency improvement is still expected.

In the above description, the phosphor layers are formed on the back panel. However, the present invention may be carried out in the same way, for a PDP in monochrome display method that is not provided with phosphor layers.

In the above description, the PDP is explained to be driven in a field time-sharing grayscale display method. However, the present invention is not limited to such, and is applicable to a PDP as long as it is driven using a method in which there are a write period and a display period, and in which sustain voltages are applied to display electrodes in the display period.

In the above description, pairs of display electrodes are provided on a front panel, and data electrodes, data-sustain electrodes, or the like are provided on a back panel. However, the present invention may also be carried out for a PDP in which a plurality of thin glass tubes are arranged in parallel to form a plane-like member, where each of the thin glass tubes is filled with discharge gas, thereby providing pairs of display electrodes on one surface of the plane-like member so as to traverse the glass tubes, and data electrodes and data-sustain electrodes, or the like are provided on the other surface of the plane-like member so as to extend along the glass tubes.

Industrial Applicability

According to a PDP apparatus and a driving method therefor, luminous efficiency is improved by increasing amplitude of voltage to be applied in a sustain period while restraining cost increase. Therefore, the present invention is advantageous if applied to a display apparatus for a computer, a television, and the like. In particular, the present invention is advantageous if applied to a large display apparatus.

1. A plasma display apparatus comprising:
a plasma display panel having an outer case provided with: pairs of display electrodes extending in a row direction; first column electrodes extending in a column direction; and second column electrodes extending in the column direction such that each first column electrode has at least one side thereof that is adjacent to a second column electrode, the first column electrodes opposing the pairs of display electrodes at a distance therefrom, a plurality of discharge cells being formed where the pairs of display electrodes face the first and second column electrodes; and
a driving unit operable to drive the plasma display panel using a method having a write period and a sustain period, the driving unit including: a data driving circuit that performs, in the write period, data voltage application selectively to the first column electrodes; and a sustain driving circuit that performs, in the sustain period, voltage application collectively to the second column electrodes.

2. The plasma display apparatus of claim 1, wherein
the first column electrodes and the second column electrodes alternate one by one.

3. The plasma display apparatus of claim 1, wherein
the first column electrodes and the second column electrodes are aligned to include at least one pair of first column electrodes that are adjacent to each other.

4. The plasma display apparatus of claim 3, wherein
the first column electrodes and the second column electrodes are aligned such that pairs of first column electrodes alternate with pairs of second column electrodes.

5. The plasma display apparatus of claim 3, wherein
a second column electrode that is aligned adjacent to the pair of adjacent first column electrodes at one side is adjacent to a first column electrode at the other side.

6. The plasma display apparatus of claim 3, wherein
the first column electrodes and the second column electrodes are aligned such that pairs of first column electrodes alternate with second column electrodes.

7. The plasma display apparatus of claim 3, wherein
the voltage that the sustain driving circuit applies to the second column electrodes in the sustain period is in pulse form.

8. The plasma display apparatus of claim 1, wherein
the second column electrodes are electrically connected to each other.

9. The plasma display apparatus of claim 1, wherein
phosphor layers are formed in the discharge cells along the second column electrodes, and the second column electrodes are shaped differently from each other depending on kinds of corresponding phosphor layers.

10. The plasma display apparatus of claim 1, wherein
phosphor layers are formed in the discharge cells along the second column electrodes, and voltages that the sustain driving circuit applies to the second column electrodes are different in voltage amplitude from each other depending on kinds of phosphor layers corresponding to the second column electrodes respectively.

11. The plasma display apparatus of claim 1, wherein
the voltage that the sustain driving circuit applies to the second column electrodes in the sustain period is in pulse form.

12. A plasma display apparatus, comprising:
a plasma display panel having an outer case provided with pairs of display electrodes extending in a row direction and column electrodes extending in a column direction, the column electrodes opposing the pairs of display electrodes at a distance therefrom, a plurality of discharge cells being formed where the pairs of display electrodes face the column electrodes; and
a driving unit operable to drive the plasma display panel using a method having a write period and a sustain period, the driving unit including: a data driving circuit that performs, in the write period, data voltage application selectively to the column electrodes; a sustain driving circuit that performs, in the sustain period, voltage application collectively to the column electrodes; and a switching unit operable to switch connection of the column electrodes, between connection to the data driving circuit and connection to the sustain driving circuit.

13. The plasma display apparatus of claim 12, wherein
(a) in the write period, the switching unit connects the column electrodes to the data driving circuit and disconnects the column electrodes from the sustain driving circuit, and
(b) in the sustain period, the switching unit connects the column electrodes to the sustain driving circuit and disconnects the column electrodes from the data driving circuit.

14. The plasma display apparatus of claim 12, wherein the switching unit includes:
a first transfer gate device positioned between the data driving circuit and the column electrodes; and
a second transfer gate device positioned between the sustain driving circuit and the column electrodes.

15. The plasma display apparatus of claim 14, wherein
the sustain driving circuit, the first and second transfer gate devices have a higher voltage resistance than a voltage resistance of the data driving circuit.

16. The plasma display apparatus of claim 14, wherein
the second transfer gate device is stored in a semiconductor chip that constitutes the sustain driving circuit.

17. A driving method used for a plasma display apparatus having a plasma display panel, the driving method having a write period and a sustain period, and the plasma display panel including an outer case provided with pairs of display electrodes extending in a row direction and first column electrodes and second column electrodes extending in a column direction, the first and second column electrodes opposing the pairs of display electrodes at a distance therefrom, a plurality of discharge cells being formed where the pairs of display electrodes face the first and second column electrodes, wherein
in the write period, data voltage application is performed selectively to the first column electrodes, thereby selectively generating write discharge in the discharge cells, and
in the sustain period, sustain voltage is applied to electrodes in each pair of display electrodes and voltage application is performed collectively to the second column electrodes, thereby generating sustain discharge in every discharge cell having undergone the write discharge in the write period.

18. A driving method used for a plasma display apparatus having a plasma display panel, the driving method having a write period and a sustain period, and the plasma display panel including an outer case provided with pairs of display electrodes extending in a row direction and column electrodes extending in a column direction, the column electrodes opposing the pairs of display electrodes at a distance therefrom, a plurality of discharge cells being formed where the pairs of display electrodes face the column electrodes, wherein
in the write period, data voltage application is performed selectively to the column electrodes by means of a data driving circuit, thereby selectively generating write discharge to the discharge cells, and
in the sustain period, sustain voltage is applied to electrodes of each pair of display electrodes and voltage application is performed collectively to the column electrodes by means of a sustain driving circuit, thereby generating sustain discharge in every discharge cell having undergone the write discharge in the write period.

19. The driving method of claim 18, wherein
(a) in the write period, the sustain driving circuit is disconnected from the column electrodes, and
(b) in the sustain period, the data driving circuit is disconnected from the column electrodes.

20. The driving method of claim 17, wherein
the voltage that the sustain driving circuit applies in the sustain period is higher in voltage amplitude than the data voltage that the data driving circuit applies in the write period.

21. The driving method of claim 17, wherein
the voltage that the sustain driving circuit applies in the sustain period is in pulse form.

22. The driving method of claim 21, wherein
electrodes of each of the pairs of display electrodes are provided with voltages in pulse waveform that are different in phase by a half period from each other and are the same in length for a High-level time period and a Low-level time period, and
the voltage that the sustain driving circuit applies has a pulse waveform that falls when 0.1-0.5 μs has passed after rising of the voltages applied to the electrodes of each of the pairs of display electrodes.

23. The driving method of claim 21, wherein
electrodes of each of the pairs of display electrodes are provided with voltages in pulse waveform that are different in phase by a half period and have a longer High-level time period than a Low-level time period, and
the voltage that the sustain driving circuit applies has a pulse waveform that falls within 0.4 μs after falling of the voltages applied to the electrodes of each of the pairs of display electrodes.

24. The driving method of claim 21, wherein
electrodes of each of the pairs of display electrodes are provided with voltages in pulse waveform that are different in phase by a half period and have a shorter High-level time period than a Low-level time period, and
the voltage that the sustain driving circuit applies in the sustain period has a pulse waveform that falls when 0.2-0.6 μs has passed after falling of the voltages applied to the electrodes of each of the pairs of display electrodes.

25. The driving method of claim 18, wherein
the voltage that the sustain driving circuit applies in the sustain period is higher in voltage amplitude than the data voltage that the data driving circuit applies in the write period.

26. The driving method of claim 18, wherein
the voltage that the sustain driving circuit applies in the sustain period is in pulse form.
